(19) United States
(12) Patent Application Publication
(10) Pub. No.: US 2011/0029988 A1
(43) Pub. Date: Feb. 3, 2011

(54) METHODS AND APPARATUS FOR FACILITATING APPLICATION INTER-COMMUNICATIONS

(75) Inventors: Vineet Mittal, San Diego, CA (US); Rajarshi Ray, San Diego, CA (US); Rajeev D. Rajan, San Diego, CA (US); Michael J. Koenig, San Diego, CA (US); Abdelkader Elmilady, San Diego, CA (US); Larissa Dantsker, San Diego, CA (US); Jatin C. Kadakia, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/534,635

(22) Filed: Aug. 3, 2009

(51) Int. Cl. G06F 9/44

(52) U.S. Cl. 719/314

(57) ABSTRACT

A method and apparatus for facilitating communication amongst a plurality of applications associated with at least one device is provided. The method may comprise receiving, by an extension module, a request from a first application to communicate with one or more applications, establishing a communication link between the first and at least one of the one or more applications, wherein the communication link allows the first and the at least one of the one or more applications to communicate at least one of data or control information, and storing, by the extension module, at least a portion of data communicated between the communicating applications.

### BACKGROUND

1. Field

The disclosed aspects relate to communications amongst a plurality applications associated with devices over a network.

2. Background

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Further, many such cellular telephones are being manufactured with relatively large increases in computing capabilities, and as such, are becoming tantamount to small personal computers and hand-held PDAs. Still further, many applications are being made available for such personal computing devices. However, these smaller and more powerful personal computing devices are typically severely resource constrained. For example, the screen size, amount of available memory and file system space, amount of input and output capabilities and processing capability may each be limited by the small size of the device. Additionally, users are increasingly wishing to enable interactivity between applications on a personal computing device. Because of such severe resource constraints, it is often typically desirable, for example, to maintain a limited size and quantity of software applications and other information residing on such remote personal computing devices, e.g., client devices.

Currently, users have limited options for determining which of many available applications may be useful. Furthermore, currently, because of the noted resource constraints, users have limited options for application interactivity. Thus, improved apparatus and methods for determining which applications may be useful are desired. Further, improved apparatus and methods for facilitating communication amongst two or more applications on a wireless device are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with facilitating communication amongst two or more applications. According to one aspect, a method for facilitating communication amongst two or more applications is provided. The method can comprise receiving, by an extension module, a request from a first application to communicate with a second application, establishing a communication link between the first and second applications, wherein the communication link allows the first and second applications to communicate at least one of data or control information, and storing, by the extension module, at least a portion of the communications between the first and second applications.

Yet another aspect relates to at least one processor configured to facilitate communication amongst two or more applications. The at least one processor can include a first module for receiving, by an extension module, a request from a first application to communicate with a second application, a second module for establishing a communication link between the first and second applications, wherein the communication link allows the first and second applications to communicate at least one of data or control information, and a third module for storing, by the extension module, at least a portion of the communications between the first and second applications.

Still another aspect relates to a computer program product comprising a computer-readable medium. The computer-readable medium can include a first set of codes for causing a computer to receive, by an extension module, a request from a first application to communicate with a second application, a second set of codes for causing the computer to establish a communication link between the first and second applications, wherein the communication link allows the first and second applications to communicate at least one of data or control information, and a third set of codes for causing the computer to store, by the extension module, at least a portion of the communications between the first and second applications.

Yet another aspect relates to an apparatus. The apparatus can include means for receiving, by an extension module, a request from a first application to communicate with a second application, means for establishing a communication link between the first and second applications, wherein the communication link allows the first and second applications to communicate at least one of data or control information, and means for storing, by the extension module, at least a portion of the communications between the first and second applications.

Another aspect relates to an apparatus. The apparatus can include an extension module for: receiving a request from a first application to communicate with a second application, and establishing a communication link between the first and second applications, wherein the communication link allows the first and second applications to communicate at least one of data or control information, and a storage module for: storing at least a portion of the communications between the first and second applications.

Furthermore, in accordance with one or more aspects and corresponding disclosure thereof, various aspects are described in connection with providing content to one or more of a plurality of devices. According to one aspect, a method for providing content to one or more of a plurality of devices is provided. The method can comprise receiving, by an extension server, from a plurality of devices, at least a portion of communications between a first application and a second application stored by an extension module on each of the plurality of devices, wherein the stored communications include at least one of data or control information for at least one of the first or second applications, obtaining at least one content item in response to the received communications, storing at least a portion of information received from the plurality of devices, analyzing the stored information from the plurality of devices, and presenting data derived from the analyzed stored information.

Yet another aspect relates to at least one processor configured to facilitate communication amongst two or more applications. The at least one processor can include a first module for receiving, by an extension server, from a plurality of devices, at least a portion of communications between a first application and a second application stored by an extension module on each of the plurality of devices, wherein the stored communications include at least one of data or control information for at least one of the first or second applications, a second module for obtaining at least one content item in response to the received communications, a third module for storing at least a portion of information received from the plurality of devices, a fourth module for analyzing the stored information from the plurality of devices, and a fifth module for presenting data derived from the analyzed stored information.

Still another aspect relates to a computer program product comprising a computer-readable medium. The computer-readable medium can include a first set of codes for causing a computer to receive, by an extension server, from a plurality of devices, at least a portion of communications between a first application and a second application stored by an extension module on each of the plurality of devices, wherein the stored communications include at least one of data or control information for at least one of the first or second applications, a second set of codes for causing the computer to obtain at least one content item in response to the received communications, and a third set of codes for causing the computer to store at least a portion of information received from the plurality of devices, a fourth set of codes for causing the computer to analyze the stored information from the plurality of devices, and a fifth set of codes for causing the computer to present data derived from the analyzed stored information.

Yet another aspect relates to an apparatus. The apparatus can include means for receiving, by an extension server, from a plurality of devices, at least a portion of communications between a first application and a second application stored by an extension module on each of the plurality of devices, wherein the stored communications include at least one of data or control information for at least one of the first or second applications, means for obtaining at least one content item in response to the received communications, means for storing at least a portion of information received from the plurality of devices, means for analyzing the stored information from the plurality of devices, and means for presenting data derived from the analyzed stored information.

Another aspect relates to an apparatus. The apparatus can include a receiver operable for: receiving from a plurality of devices, at least a portion of communications between a first application and a second application stored by an extension module on each of the plurality of devices, wherein the stored communications include at least one of data or control information for at least one of the first or second applications, and an application server module operable for: obtaining at least one content item in response to the received communications, storing at least a portion of information received from the plurality of devices, analyzing the stored information from the plurality of devices, and presenting data derived from the analyzed stored information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a block diagram of a communication network according to an aspect;

FIG. 2A illustrates a message sequence chart of operation of an aspect depicted in FIG. 1;

FIG. 2B illustrates a message sequence chart of operation of an aspect depicted in FIG. 1;

FIG. 3 illustrates exemplary screen shots over multiple time intervals according to an aspect;

FIG. 4 illustrates a block diagram example architecture of a communications device;

FIG. 5 illustrates exemplary block diagram of an extension system according to an aspect;

FIG. 6 illustrates a block diagram of an exemplary communications device that can facilitate communication amongst two or more applications;

FIG. 7 illustrates a block diagram of an exemplary network device that can provide content to one or more of a plurality of devices;

FIG. 8 illustrates an exemplary multiple access wireless communication system according to an aspect;

FIG. 9 depicts a block diagram of an exemplary communication system.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The communication of content amongst wireless devices and amongst applications within devices may be accomplished through using a communication path established and maintained through extension modules and/or servers over a network. As used in the following description, an application may include, but is not limited to, a program, and/or segments, modules, snippets, etc. of a program. In particular, the present aspects enable wireless devices and associated applications to set up and maintain inter-application communication paths to exchange content, e.g., voice, text, video, and other multimedia content, without requiring dedicated hard-coding within each application. Further, an extension module may store and/or track communications amongst applications and use such information to add functionality to applications and/or to send such information to a server for aggregating with information obtained from other devices.

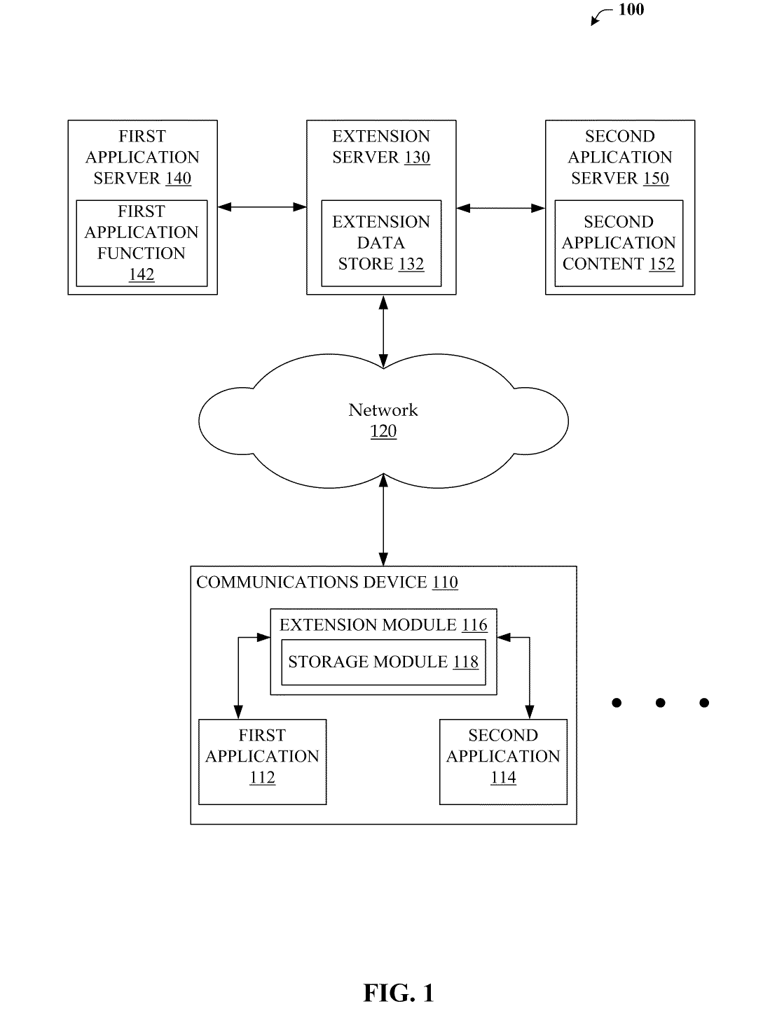

With reference to FIG. 1, a block diagram of a communication network 100 according to an aspect is illustrated. Communication network 100 may include one or more of communications devices 110 (FIG. 1 depicts an ellipsis next to communications device 110 as a representation of a possible plurality of devices not shown) connected to a communication network 120, e.g., a CDMA network, a GPRS network, a UMTS network, and other types of communication networks. Communication network 100 may further include a plurality of servers 130, 140, 150 connected to communication network 120. In one aspect, the plurality of servers includes extension server 130, first application server 140 and second application server 150.

In one aspect, communications device 110 may further include a plurality of applications, such as first application 112 and second application 114. In one aspect, to facilitate inter-application communications, communications device 110 may include extension module 116. In such an aspect, extension module 116 may act at least as a medium of communication between two or more applications (112, 114) on a communications device 110 and/or between any application (112, 114) on a communication device 110 and an extension server 130. In one aspect, first application 112 may communicate directly with other applications, such as second application 114. In another aspect, execution of an portions of application of the device may be distributed the device and the server, such as extension server 130. For example, extension server 130 may be used to execute and/or process resource intensive aspects and such processed data may then be transmitted to the device

In operation, extension module 116 may obtain a request from an application, such as first application 112, to interact with one or more other applications, such as second application 114. In such an aspect, extension module 116 may obtain data and/or control information from one or more applications interacting through extension module 116 and may store such data and/or control information in storage module 118. In one aspect, first application 112 may send an object to multiple other applications through extension module 116. In one aspect, the object may include: a command, control information, data, a message, etc. In such an aspect, extension module 116 may queue the multiple received objects. Further, extension module 116 may prioritize which objects are served to which applications in what order. Such prioritization may be defined through defaults setting, may be determined by the first application, may be modified by a user select, etc. Still further, extension module 116 may serve the multiple commands using any available process, such as, round-robin serving, time-sliced serving, etc.

In one aspect, data and/or control information stored in storage module 118 may be retrieved by one or more interacting applications. In such an aspect, such stored information may be used to profile a user with respect to application usage, service request, etc. In another such aspect, such stored information may be used by a server or the like to assist in selecting additional content to be made available to the device 110. For example, user profile information may be used to assist in determining which coupons, advertisements, etc are pushed to the device. In another aspect, at least a portion of such data and/or control information may be shared with other applications and/or a server, such as extension server 130. In one aspect, extension server 130 may retain at least a portion of the transmitted data and/or control information with extension data store 132. In such an aspect, such shared information be produced by one or more of the applications, and/or may be obtained from an application and/or server that has aggregated additional sources of data and may be made available upon request from one or more of the applications.

In one aspect, extension module 116 may request content and/or additional functionality associated with one or more of the interacting applications on communications device 110. In such an aspect, the request may be transmitted to extension server 130, via network 120. Extension server 130 may be communicatively coupled to one or more application servers, such first application server 140 and second application server 150. In one operational example, a request from first application 112 for an added functionality may be sent to extension module 116. Extension module 116 may store at least a portion of information associated with the requested functionality with storage module 118 and may transmit the request to extension server 130 via network 120. Extension server 130 may store at least a portion of the request with extension data store 132 and may communicate the request to first application server 140 to retrieve first function 142. In such an example operation, first function 142 may be transmitted to communications device 110 to provide the requested functionality for first application 112. In another operational example, a request from second application 114 for added content may be sent to extension module 116. Extension module 116 may store at least a portion of information associated with the requested content with storage module 118 and may transmit the request to extension server 130 via network 120. Extension server 130 may store at least a portion of the request with extension data store 132 and may communicate the request to second application server 150 to retrieve second content 152. In such an example operation, second content 152 may be transmitted to communications device 110 to provide the requested content for second application 114.

In one aspect, extension server 130 may aggregate at least a portion of data and information stored in extension data store 132 to generate metrics and/or data associated with the one or more applications 112, 114 and/or application servers 140, 150. For example, extension server 130 may store information associated with interactions between a user and an application of a communications device, such as communications device 110. In such an example, extension server 130 may aggregate similar data from multiple communications devices 110 to generate data, such as rankings for which applications 112, 114 are most often used.

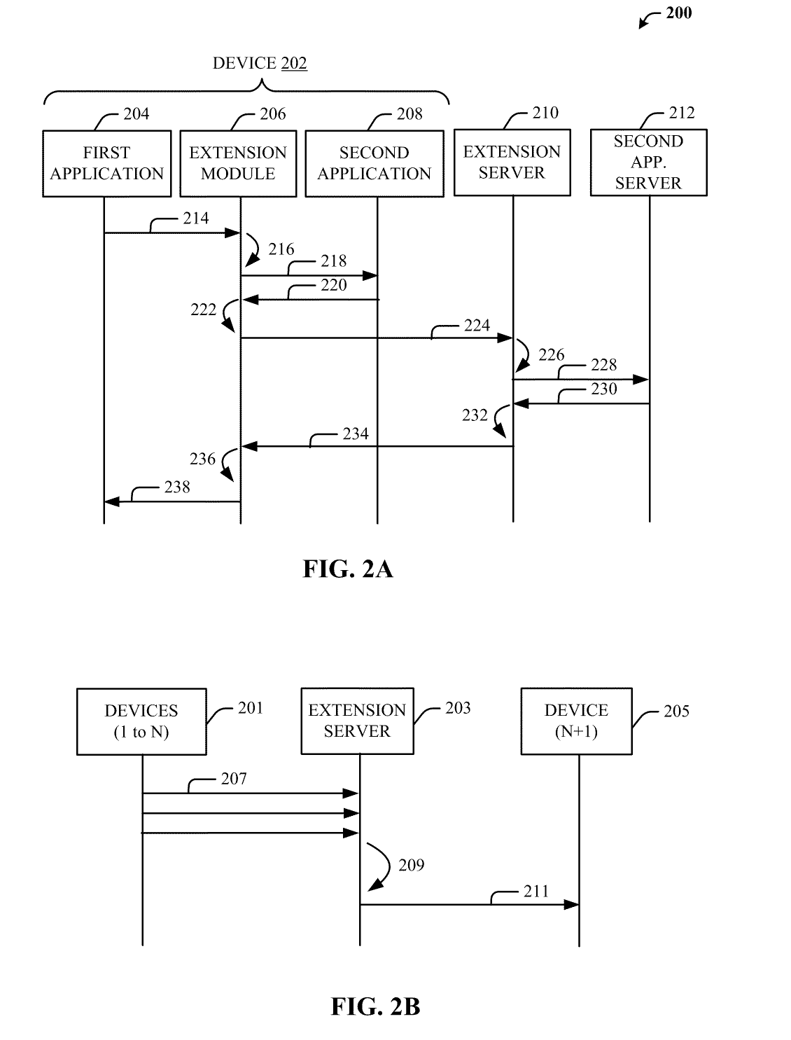

With reference to FIGS. 2A and 2B, operation of the subject matter depicted in FIG. 1 in the form of a message sequence diagram is illustrated. Specifically, with reference to FIG. 2A, interactions within a device and with a plurality of servers depicted in the form of a message sequence diagram is illustrated. Further, with reference to FIG. 2B, interactions between a plurality of devices and a plurality of servers depicted in the form of a message sequence diagram are illustrated. Generally, on communications device 202, first application 204 requests data, control, and/or information from second application 208 through extension module. Further, in the depicted example, device 202 may contact extension server 210 to obtain content, functionality, and/or information from second application server 212. In one aspect, establishing a connection between device 202 and servers 210, 212 may include using a JSON, XML or other similar request and response protocol. In another aspect, the connection is established using TCP/IP, UDP, etc., a native link, or a network level protocol. In yet another aspect, higher level application level protocols such as http, https, etc. enable transaction level activity to facilitate the connection. In one aspect, the messages may be transmitted using a short message service such as an SMS message. In another, content, functionality, etc. received from a server may be encrypted. In another aspect, the content, functionality, etc. may be digitally signed to prevent tampering. In the aspect depicted in FIG. 2, only one destination application server is shown for clarity of presentation and does not limit the scope of the claimed subject matter. In another aspect, multiple destination application servers may receive requests from multiple communications devices 202.

Returning to the description of the FIG. 2A message sequence diagram, first application 204 may request data, control, etc. of second application 208 at sequence step 214. At sequence step 216, at least a portion of said request may be stored with extension module 206. Further, at sequence step 216, said request may be translated, modified, reformatted, etc. to be able to be received by second application 208. In one aspect, extension module 206 may exchange data formats to facilitate communications between applications. In another aspect, extension module 206 may provide a general command format in which applications may populate applicable fields. For example, a general command format may include: an application identifier; a command identifier, such as, set volume, purchase, register notify, get next purchase, etc.; and one or more command parameters associated with the command identifier. Continuing the example, an FM RDS application may include command identifiers, such as but not limited to, launch FM radio, mute FM radio, un-mute FM radio, increase volume, decrease volume, set volume to max, start FM radio with audio only, start FM radio with RDS only, start FM radio with both RDS and audio available, etc. At sequence step 218, the request is sent to second application. In one aspect, the request may include a request to activate, use, deactivate, etc., certain functions, content, etc., associated with second application 208. For example, first application 204 may request second application 208 to purchase audio content described in the request from first application 204. In another aspect, the request may originate from the second application for information made available by the first application to the extension module. At sequence step 220, second application 208 sends a response to extension module 206. In one aspect, said response may include the information, content, etc. requested by the first application. In such an application, extension module 206 may relay said response from second application 208 to first application 204. In another aspect, the response at sequence step 220 includes a request to obtain content, functionalities, etc., from a server or the like. In such an aspect, at sequence step 222, extension module 206 may store at least a portion of the message conveyed at sequence step 220. Further, at sequence step 224, extension module 206 may transmit the request from second application 208 to extension server 210.

At sequence step 226, extension server 210 may store at least a portion of the information associated with the request of sequence step 224. In the depicted example, at sequence step 228, extension server 210 may relay the request from second application 208 to second application sever 212. For example, a request may include a request for audio content, such as the audio content requested in the above referenced example. At sequence step 230, requested content, functionality etc. is sent back to extension server 210 for eventual transmission to device 202. In one aspect, at sequence step 232, extension server 210 may store at least a portion of the data associated with the received transmission from sequence step 230. Thereafter, in one aspect, at sequence step 234, content received from second application server 212 is transmitted to the requesting device and/or devices 202.

In one aspect, at sequence step 236, extension module 206 may store at least a portion of the data received from sequence step 234. In one aspect, such stored information may be made available for additional applications. In another aspect, additionally or in the alternative, such stored information may be aggregated to generate user metrics. For example, extension module 206 may store information relating to a received audio file, such as frequency of plays, etc. In another aspect, received data may include a new application and/or added functionality to an existing application. In such an aspect, extension module 206 may store information such as, frequency of usage, etc.

Turning now to the description of FIG. 2B, interactions amongst a plurality of devices and a plurality of servers depicted in the form of a message sequence diagram are illustrated. As described briefly with reference to FIG. 2A, extension module 206 and/or extension server 210 may store data associated with processing requests and/or receiving responses from various applications, servers, etc. Generally, such stored data may be aggregated to generate user related metrics. Referring now to FIG. 2B, at sequence step 207, multiple devices 201 may transmit content, information, etc. to extension server 203. In one aspect, such transmitted content may include requests, application usage data such as, start time, stop time, usage duration, etc., user input data such as key strokes, audio inputs, etc., location determination data, such as GPS data, from various applications on any of the multiple devices 201. In another aspect, such transmitted content may include aggregated content information from an extension module associated with any of the multiple devices 201. At sequence step 209, the multiple received content items are processed by the extension server. In one aspect, such processing may include aggregating data associated with requests received from multiple devices 201. In another aspect, such processing may include processing of data aggregated by an extension module associated with any of multiple devices 201. For example, processed data may result in generating user related metrics, such as, frequency of content usage, peak time of day usage, popularity over time, various weighted averages of usage, etc. At sequence step 211, in one aspect, such generated metrics may be transmitted to device 205. In one aspect, device 205 may include any of devices 201, application servers, service provider servers, third party servers, etc. As such, along with facilitating communications between multiple applications, extension module 206 and/or extension server 210, 203, may obtain, process, aggregate, or generate data associated with information obtained through the communications facilitating.

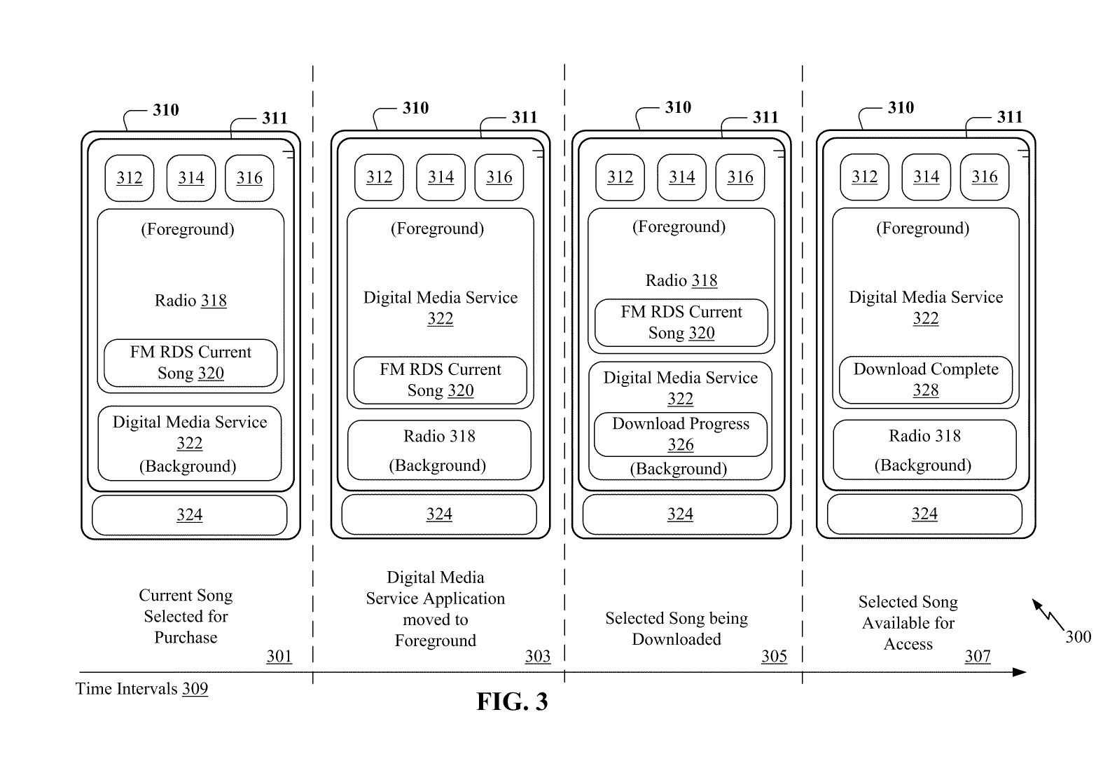

With reference to FIG. 3, exemplary screen shots depicting an interaction between two applications on a communications device 310 in a communication system 300 as time 309 progresses, as indicated by the left-to-right arrow. As depicted, communications device 310 may include input mechanisms 324 for generating inputs into communications device 310, and output mechanism 311 for generating information for consumption by the user of communications device 310. For example, input mechanism 324 may include a mechanism such as a key or keyboard, a mouse, a touch-screen display, a microphone, etc. Further, for example, output mechanism 311 may include a display, an audio speaker, a haptic feedback mechanism, a Personal Area Network (PAN) transceiver, etc. In the illustrated aspects, the output mechanism 311 may include a display operable to present media content that is in image or video format and/or an audio speaker to present media content that is in an audio format. In one aspect, a user may be interacting with a selected application 318 in the foreground, while another application 322 may be running in the background. Furthermore, in the depicted aspect, communications device 310 presents a user with a display including options to run any of a plurality of additional applications (312, 314, 316).

In the depicted aspect, at the first time interval 301, FM radio application 322 is running in the foreground while digital media service application 322 is running in the background of communications device 310. Furthermore, in the depicted aspect, FM radio application 318 may include FM RDS data 420 associated with content playing on FM radio application 318. In one aspect, at first time interval 301, a user may select to purchase the song currently playing through FM radio application 318. In such an aspect, song information may be obtained from FM RDS data 320 associated with FM radio application 318. Once such information is obtained, a request may be made, within device 310, to activate and/or interact with an application capable of purchasing the selected song, such as digital media service application 322. In such an aspect, interactions amongst the applications may be facilitated and/or monitored by an extension module within device 310.

In the depicted aspect, at second time interval 303, digital media service application 322 has been moved to the foreground while FM radio application 318 has been moved to the background to allow the user to interact with an application capable of purchasing the requested song. Furthermore, in such an aspect, FM RDS data 320 for the selected song has been communicated to digital media service application 322. In one aspect, such communications between the applications may again be facilitated and/or monitored by an extension module within device 310. Additionally, at second time interval 303, the user may select to purchase the song through digital media service application 322.

In the depicted aspect, at third time interval 305, upon receipt of the selection to purchase the song, FM radio module 318 may be returned to the foreground while digital media service 322 may be returned to background operations. In the depicted example, download progress display 326, or the like, may be presented to the user while digital media service processes the user request. In one aspect, information associated with the selected content item may be monitored by an extension module within device 310.

In the depicted aspect, at fourth time interval 307, upon completion of downloading the selected song, digital media service 322 may be returned to foreground operations, while FM radio application 318 may be sent to background operations so as to allow the user to access the newly acquired song. In one aspect, such communications between the applications may again be facilitated and/or monitored by an extension module within device 310.

As such, communications between multiple applications may be facilitated and/or monitored by an extension module within device 310. Further, an extension module may facilitate communication of data between applications. In the depicted example, FM RDS data was shared between the two applications through the extension module. Still further, such an extension module may facilitate control of one or more applications by one or more other applications. In the depicted example, the extension module allowed one application to control whether other application operated in the foreground or background. In another aspect, an extension module may allow an application to control volume, display, and/or various functions of another application. By way of example and not limitation, an application may control in what mode another application is run, e.g., FM audio only, RDS only, or FM and RDS both. Further, a first application may control a second application and prompt the second application to display information such as, Top 10 songs, or display music shop, etc. Still further, data shared amongst applications may include, for example, a text received over the air (OTA), specific predefined contextual items such as a song name, an artist name, a movie name, etc. based at least in part on availability of such data.

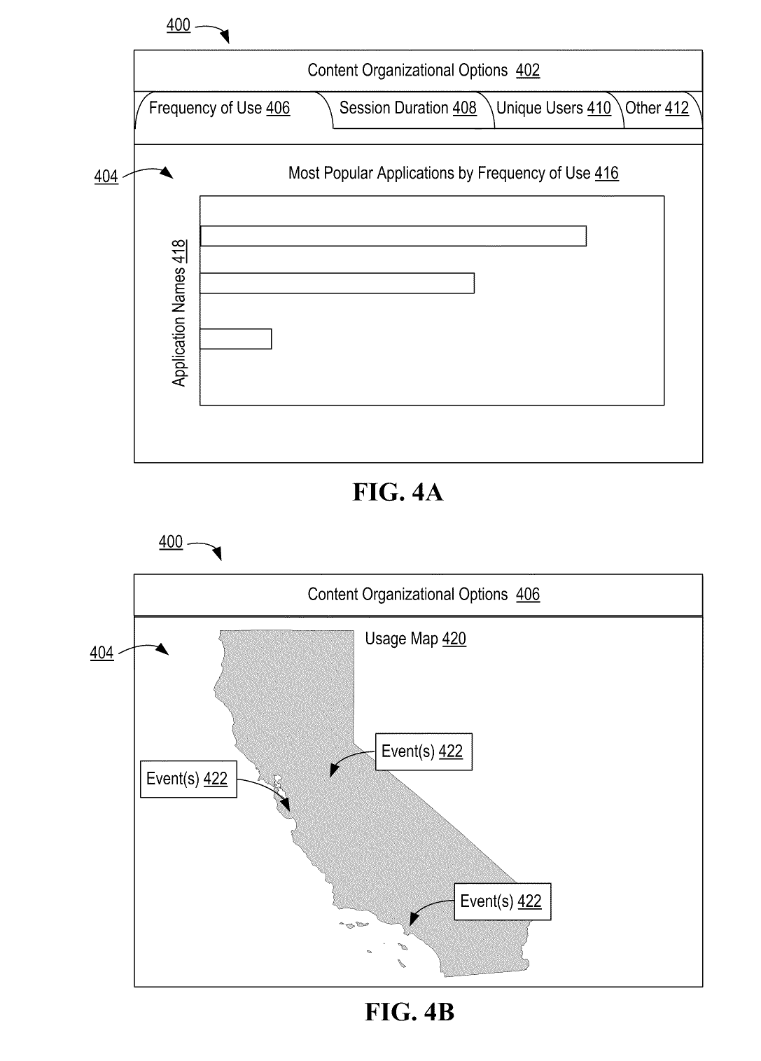

With reference to FIGS. 4A and 4B, exemplary screen shots 400 depicting possible presentation options for analytics and/or statistics derived from content, such as content and information 207 depicted in FIG. 2B, received from one or more communications devices, such as communications device 110 depicted in FIG. 1. In the depicted screen shots, the display may include analytics and/or statistics described herein as content organizational options 402, and a graphical display 404 derived at least in part from analytics and/or statistics associated with received content or the like. In one aspect, content organizational options 402 may include one or more categories, such as but not limited to: maps, popularity of applications, trends, reviews, feedback, application specific metrics, etc. Further, in such an aspect, one or more categories may include one or more subcategories, for example as depicted: frequency of usage 406, session duration 408, number of unique users 410, and any number of other 412 subcategories, such as but not limited to: number of times an application has been used, usage location, usage time of day, usage per service plan, user activity during usage, such as stationary, walking, driving, use of mass transportation, etc., usage over a predefined duration of time, such as a day, a week, weekends only, etc. Furthermore, such presented content may be refreshed, on a real time basis, periodically, upon user request, etc.

Turning now to FIG. 4A, an exemplary screen shot 400 of a graph of popularity of various applications by frequency of use 416 is depicted. In the depicted aspect, received content may be analyzed and/or aggregated to generate various metrics which may be presented to a user or the like. Further, the depicted aspect, presents a display in which content organizational options 402 includes a top applications category. Further, such a category may include subcategories of: frequency of usage 406, session duration 408, unique users 410, or other 412 possible subcategories. Still further, in the depicted screen shot, frequency of use 406 presents a display graph including various applications, organized by name 418 in this non-limiting aspect. In operation, a user may determine which among available applications may be of repeated usefulness through interpreting the displayed graph.

Turning now to FIG. 4B, an exemplary screen shot 400 of a usage map 420 is depicted. In one aspect, usage map 420 may cover one or more predefined geographic regions, such as a household, a campus, a city, a state, a region, a country, etc. In the depicted aspect, one or more events 422 may be displayed on usage map 420. Such events 422 may include content information received from one or more devices. For example, event 420 may indicate where an application is used, where a specific user has used an application, etc. In another example, any of the categories and/or subcategories described above may be displayed on usage map 420. Further, displayed data may be averaged, aggregated, pooled, etc. over various predetermined geographic regions. For example, usage map 420 may display usage of a specific application at a city, campus, building, etc., where event 422 displayed for each locality includes multiple events pooled from said locality. In another aspect, event 422 may be present occurrences of a predefined duration of time, such as a day, week, etc. In still another aspect, updating of event 422 data may occur on a real time basis, periodically, upon user request, etc.

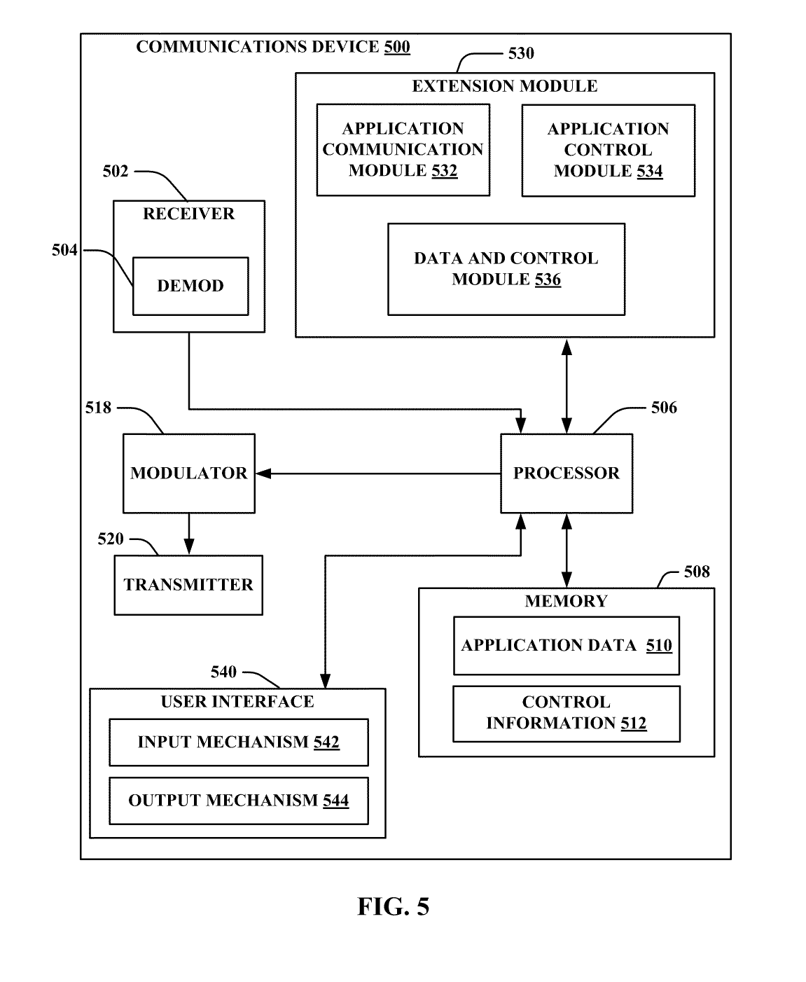

While still referencing FIG. 1, but turning also now to FIG. 5, an example architecture of communications device 110 is illustrated. As depicted in FIG. 5, wireless device 500 comprises receiver 502 that receives a signal from, for instance, a receive antenna (not shown), performs typical actions on (e.g., filters, amplifies, downconverts, etc.) the received signal, and digitizes the conditioned signal to obtain samples. Receiver 502 can comprise a demodulator 504 that can demodulate received symbols and provide them to processor 506 for channel estimation. Processor 506 can be a processor dedicated to analyzing information received by receiver 502 and/or generating information for transmission by transmitter 520, a processor that controls one or more components of mobile device 500, and/or a processor that both analyzes information received by receiver 502, generates information for transmission by transmitter 520, and controls one or more components of mobile device 500.

Mobile device 500 can additionally comprise memory 508 that is operatively coupled to processor 506 and that can store data to be transmitted, received data, information related to available channels, data associated with analyzed signal and/or interference strength, information related to an assigned channel, power, rate, or the like, and any other suitable information for estimating a channel and communicating via the channel. In one aspect, memory 508 can include application data 510, such as but not limited to, user generated content, pictures, screen captures, voice recordings, etc. In one aspect, user generated content may include visual and/or non-visual content, for example: photos, sound files, text messages, etc. In one aspect, sound files may be stored in any number of file formats, such as: .qcp, .wav, .aac, etc. In one aspect, photos may be stored in any number of file formats, such as: .gif, .jpeg, .tiff, .bmp, etc. In one aspect, memory 508 can include control information 512, such as information to allow a requesting application to perform at least one of: initiating a requested application, changing the requested application to background running status, changing the requested application to foreground running status, changing the requested application to idle mode status, or terminating the requested application. In one aspect, control information 512 may further include allowing a requesting application to perform at least one of: modifying a volume associated with a requested application, modifying a display characteristic associated with the requested application, modifying an input option associated with the requested application, or modifying an output option associated with the requested application. In one aspect, control information 512 includes at least one of status control or state control information for at least one of a first or a second application. Memory 508 can additionally store protocols and/or algorithms associated with estimating and/or utilizing a channel (e.g., performance based, capacity based, etc.).

It will be appreciated that data store (e.g., memory 508) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 508 of the subject systems and methods may comprise, without being limited to, these and any other suitable types of memory.

Mobile device 500 can further include extension module 530 to facilitate and/or monitor inter-application communications within device 500. Extension module 530 may further comprise application communication module 532 to assist extension module 530 in formatting, translating, facilitating, etc. communication of application data 510 among applications, within communication devices 500. Extension module 530 may further comprise application control module 534 to assist extension module 530 in allowing one or more applications in control and/or influence operations of one or more other applications. In one aspect, application control module 534 may allow a requesting application to perform at least one of: modifying a volume associated with a requested application, modifying a display characteristic associated with the requested application, modifying an input option associated with the requested application, or modifying an output option associated with the requested application. Additionally, extension module 530 may further comprise data and control module 536 to monitor, track, obtain and/or collect at least a portion of application data 510 and/or control information 512 transmitted between applications, to servers, etc. In one aspect, data and control module 536 may transmit at least a portion of the stored communications to at least one of: the requesting application, the requested application, a third application, or one or more servers. In one aspect, a JSON, XML or other similar request and response protocol may be used for transmissions to the one or more servers.

Additionally, mobile device 500 may include user interface 540. User interface 540 may include input mechanisms 542 for generating inputs into communications device 500, and output mechanism 542 for generating information for consumption by the user of the communications device 500. For example, input mechanism 542 may include a mechanism such as a key or keyboard, a mouse, a touch-screen display, a microphone, etc. Further, for example, output mechanism 544 may include a display, an audio speaker, a haptic feedback mechanism, a Personal Area Network (PAN) transceiver etc. In the illustrated aspects, the output mechanism 544 may include a display operable to present media content that is in image or video format or an audio speaker to present media content that is in an audio format.

In operation, a user may prompt the communications device 500 to initiate a first application through a second application. For example, first application may be an FM-RDS application; the second application may be a music download service application. Extension module 530 may facilitate communication of application data 510 and control information 512 between at least two applications through the use of application communication module 532 and application control module 534. For example, communicated application data 510 may include at least a portion of RDS data or digital music data, control information 512 may include control of a music download service application purchasing function, volume, display, etc. Furthermore, data and control module 536 may obtain and/or store at least a portion of application data 510 and control information 512 communicated between applications. For example, communications stored may include at least a portion of: the RDS data, or the digital music data, or a purchasing record, or any combination thereof. Exemplary screen shots of multiple communications devices applications on device 500 are presented and discussed in greater depth with reference to FIG. 3.

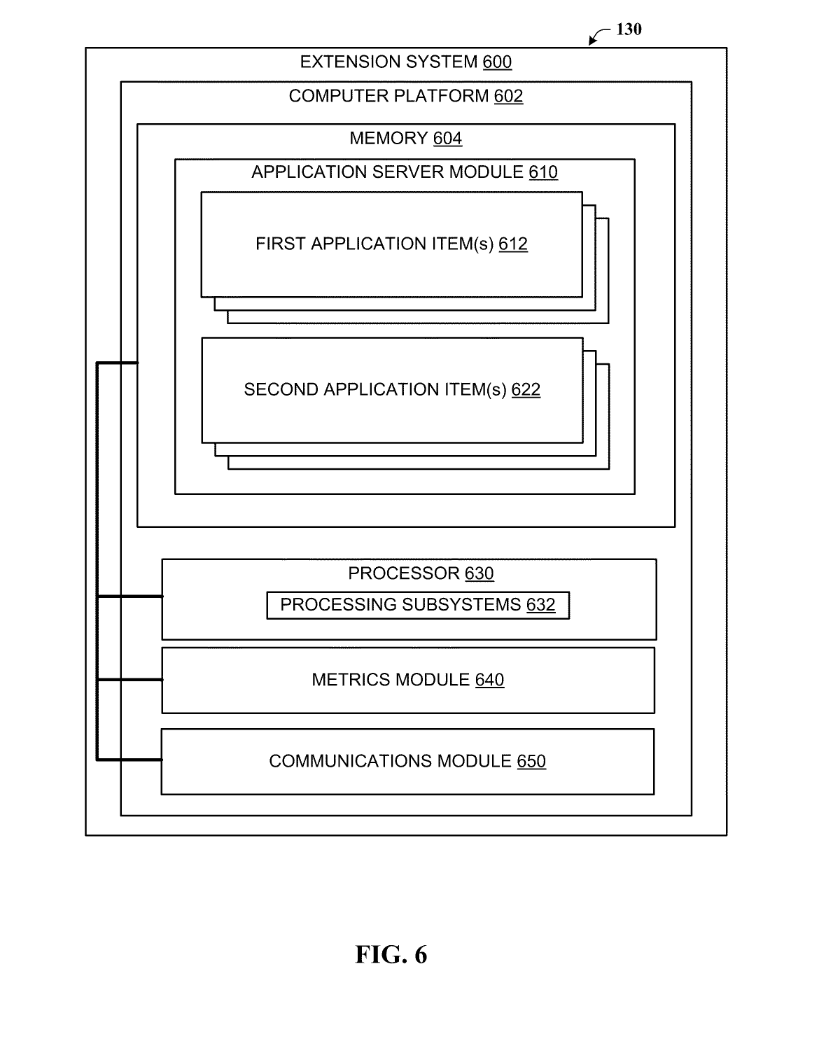

With reference to FIG. 6, illustrated is a detailed block diagram of extension system 600, such as extension server 130 depicted in FIG. 1. Extension system 600 may comprise at least one of any type of hardware, server, personal computer, mini computer, mainframe computer, or any computing device either special purpose or general computing device. Further, the modules and applications described herein as being operated on or executed by extension system 600 may be executed entirely on a single network device, as shown in FIG. 6, or alternatively, in other aspects, separate servers, databases or computer devices may work in concert to provide data in usable formats to parties, and/or to provide a separate layer of control in the data flow between communications devices 110 and the modules and applications executed by extension system 600.

Extension system 600 includes computer platform 602 that can transmit and receive data across wired and wireless networks, and that can execute routines and applications. Computer platform 602 includes memory 604, which may comprise volatile and nonvolatile memory such as read-only and/or random-access memory (ROM and RAM), EPROM, EEPROM, flash cards, or any memory common to computer platforms. Further, memory 604 may include one or more flash memory cells, or may be any secondary or tertiary storage device, such as magnetic media, optical media, tape, or soft or hard disk. Further, computer platform 602 also includes processor 630, which may be an application-specific integrated circuit (“ASIC”), or other chipset, logic circuit, or other data processing device. Processor 630 may include various processing subsystems 632 embodied in hardware, firmware, software, and combinations thereof, that enable the functionality of media content distribution system 14 and the operability of the network device on a wired or wireless network.

Computer platform 602 further includes communications module 650 embodied in hardware, firmware, software, and combinations thereof, that enables communications among the various components of extension system 600, as well as between extension system 600, devices 110, and application servers 140, 150. Communication module 650 may include the requisite hardware, firmware, software and/or combinations thereof for establishing a wireless communication connection. According to described aspects, communication module 650 may include the necessary hardware, firmware and/or software to facilitate wireless broadcast, multicast and/or unicast communication of first application content 612 and second application content 622.

Computer platform 602 further includes metrics module 640 embodied in hardware, firmware, software, and combinations thereof, that enables metrics received from device 110 corresponding to, among other things, data communicated between applications on device 110 and/or control information for applications on device 110. In one aspect, extension system 600 may analyze data received through metrics module 640 to modify first application content 612, and/or second application content 622. For example, if the metrics module returns data indicating the user is actively interacting with first application content 612 while not interacting as often with second application content 622, then the extension system 600 may suggest content similar to first application content 612. Additionally, the cost per transmission, or the like, to the first application content 612 may be increased.

Memory 604 of extension system 600 includes an application server module 610 operable to facilitate interactions with application servers, such as application servers 140, 150 depicted in FIG. 1, and devices 110 across wireless or wired network 120. Application server module 610 may provide for unicast delivery, broadcast delivery, multicast delivery or any other known or future known wireless delivery mechanism capable of delivering the functionality such as first application content 612 across a network 120. Each item of application content 612, 614 may include associated metadata to assist metrics module 640 in analyzing application related data.

In operation, for example, device 110 may request an audio file through an extension module on device 110. Such a request may be processed by extension system 600 and an application server associated with the requesting application may be contacted to obtain the requested audio file. Upon receipt of the audio file, extension system 600 may transmit the audio file to the requesting device. During processing of such a request, extension server may store information related to device 110, the requested audio file, the application server used, etc. Such information, along with information obtained from other devices, may be analyzed by metrics module 640 and results such as, song popularity, number of times a song has been played, communication capacity for the application server, etc., may be derived.

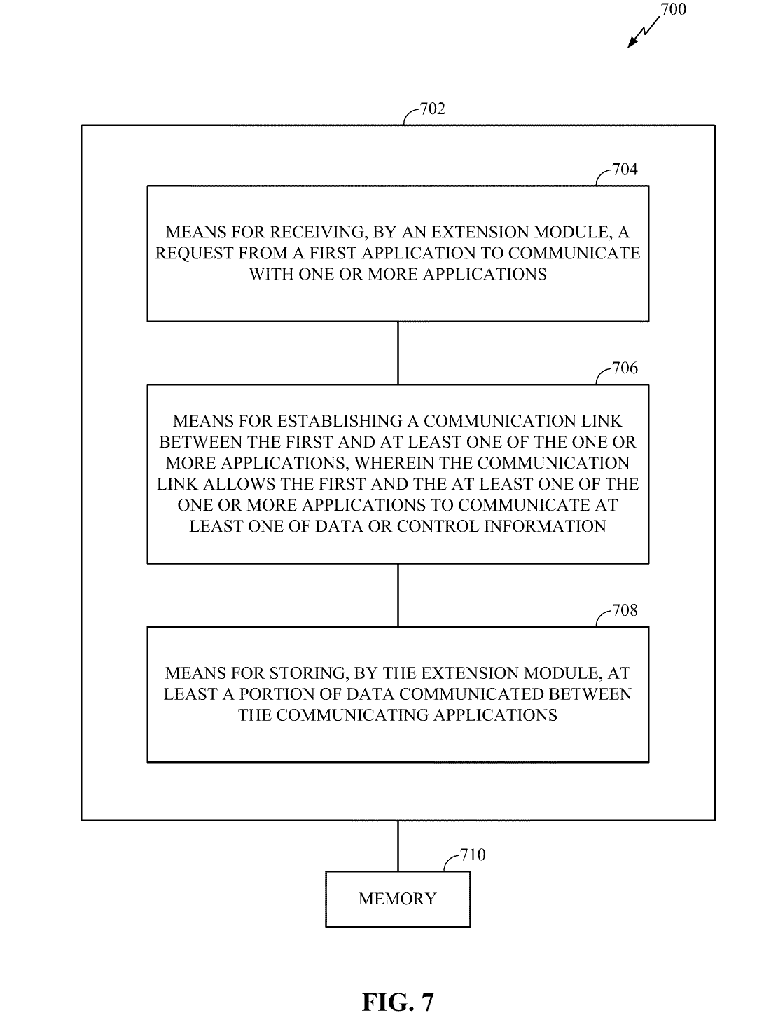

With reference to FIG. 7, a block diagram of an exemplary system 700 that can facilitate communication between two or more of applications is illustrated. For example, system 700 can reside at least partially within a wireless device. According to another example aspect, system 700 can reside at least partially within an access terminal. It is to be appreciated that system 700 is represented as including functional blocks, which can be functional blocks that represent functions implemented by a processor, software, or combination thereof (e.g., firmware). System 700 includes a logical grouping 702 of means that can act in conjunction. For instance, logical grouping 702 can include means for receiving, by an extension module, a request from a first application to communicate with second application 704. For example, a user may be running a radio application with FM RDS functionality and such a user may wish to purchase a song or program playing through the radio application. In such an aspect, an extension module may receive the request from the radio application to purchase the content. Further, logical grouping 702 can comprise means for establishing a communication link between the first and second applications, wherein the communication link allows the first and second applications to communicate at least one of data or control information 706. Continuing the above referenced example, an extension module may translate and/or communicate such a request to a digital media service application that is capable of purchasing the selected content. Additionally, an extension module may facilitate control of the digital media service application by the radio application. Further, logical grouping 702 can comprise means for storing, by the extension module, at least a portion of the communications between the first and second applications 708. Further continuing the above example, the extension module may store information related to the request by the radio application and any control information associated with the applications. As such, an extension module may facilitate communication and/or control between two or more application while retaining at least a portion of any shared data or control information for possible subsequent usage. Additionally, system 700 can include a memory 710 that retains instructions for executing functions associated with the means 704, 706 and 708. While shown as being external to memory 710, it is to be understood that one or more of the means 704, 706 and 708 can exist within memory 710.

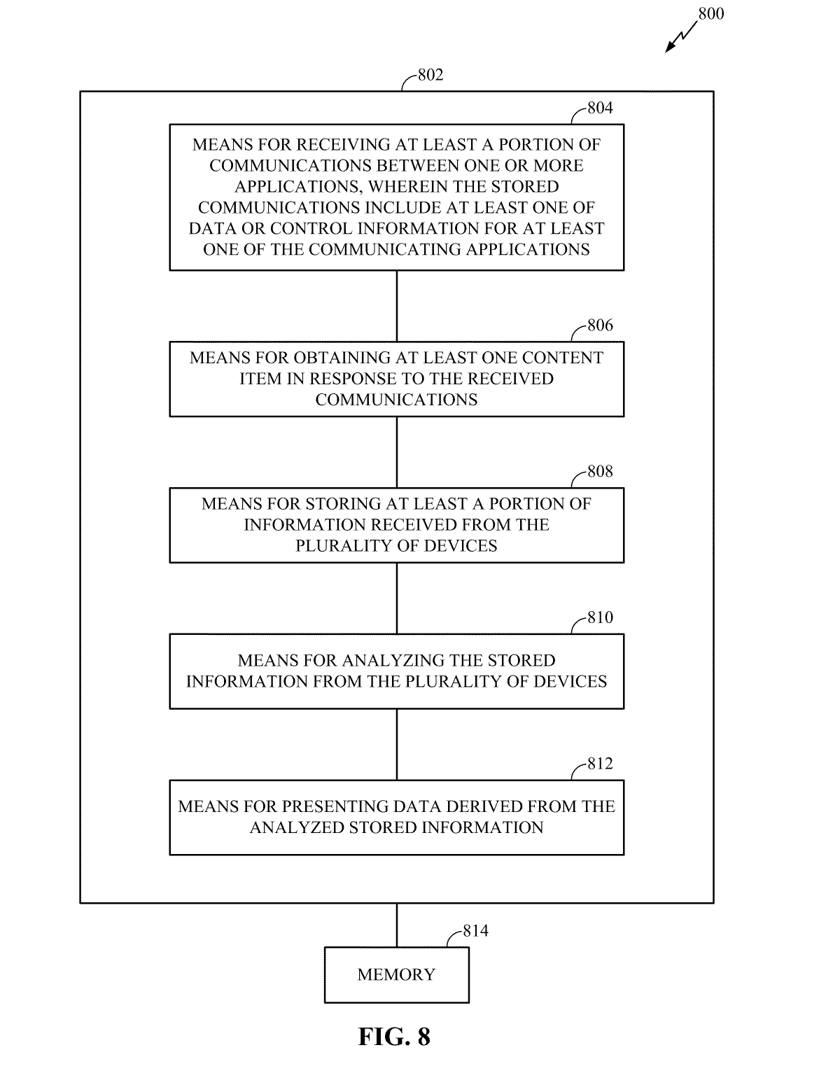

With reference to FIG. 8, a block diagram of an exemplary system 800 that can provide functionalities to one or more of a plurality of devices is illustrated. For example, system 800 can reside at least partially within a wireless device. According to another example aspect, system 800 can reside at least partially within an access terminal. It is to be appreciated that system 800 is represented as including functional blocks, which can be functional blocks that represent functions implemented by a processor, software, or combination thereof (e.g., firmware). System 800 includes a logical grouping 802 of means that can act in conjunction. For instance, logical grouping 802 can include means for receiving, by an extension server, from a plurality of devices, at least a portion of communications between a first application and a second application stored by an extension module on each of the plurality of devices, wherein the stored communications include at least one of data or control information for at least one of the first or second applications 804. In one aspect, the received communications may include a file request, such as but not limited to, a request for one or more audio files, executable files, video files, multi-media files, etc. Furthermore, in one aspect, communications between the extension service and the plurality of devices may be performed using a JSON, XML or other similar request and response protocol. Further, logical grouping 802 can comprise means for obtaining at least one content item in response to the received communications 806. For example, the content item request may include a request for an audio file, an executable file, a video file, a multi-media file, etc. Further, logical grouping 802 can comprise means for storing at least a portion of information received from the plurality of devices 808. Further, logical grouping 802 can comprise means for analyzing the stored information from the plurality of devices 810. For example, frequency of usage of a content item may be analyzed. Further, logical grouping 802 can comprise means for presenting data derived from the analyzed stored information 812. In one aspect, such presentation may be made available through a website providing rankings, ratings, etc., for usage and other metrics associated with various content items. As such, a server may receive, store, analyze, and present requests and information related to the requests for content items from a plurality of devices. Additionally, system 800 can include a memory 814 that retains instructions for executing functions associated with the means 804, 806, 808, 810 and 812. While shown as being external to memory 814, it is to be understood that one or more of the means 804, 806, 808, 810 and 812 can exist within memory 814.

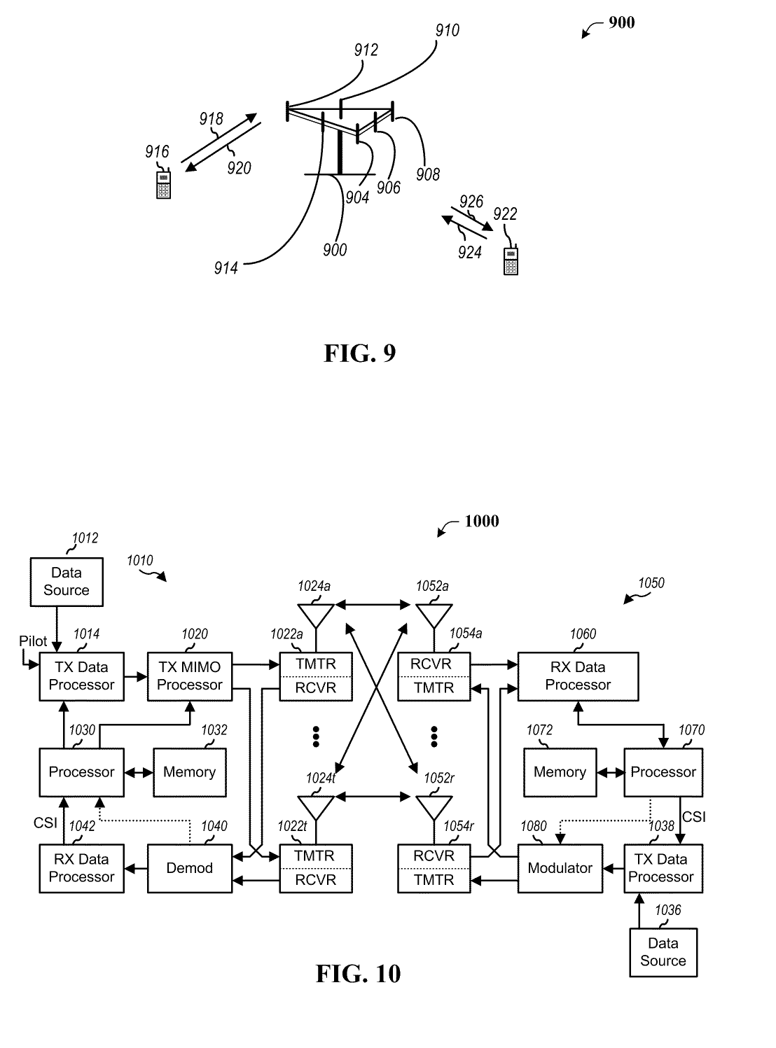

Referring to FIG. 9, a multiple access wireless communication system according to one aspect is illustrated. An access point 900 (AP) includes multiple antenna groups, one including 904 and 906, another including 908 and 910, and an additional including 912 and 914. In FIG. 9, only two antennas are shown for each antenna group, however, more or fewer antennas may be utilized for each antenna group. Access terminal 916 (AT) is in communication with antennas 912 and 914, where antennas 912 and 914 transmit information to access terminal 916 over forward link 920 and receive information from access terminal 916 over reverse link 918. Access terminal 922 is in communication with antennas 906 and 908, where antennas 906 and 908 transmit information to access terminal 922 over forward link 926 and receive information from access terminal 922 over reverse link 924. In a FDD system, communication links 918, 920, 924 and 926 may use different frequency for communication. For example, forward link 920 may use a different frequency then that used by reverse link 918.

Each group of antennas and/or the area in which they are designed to communicate is often referred to as a sector of the access point. In the aspect, antenna groups each are designed to communicate to access terminals in a sector, of the areas covered by access point 900.

In communication over forward links 920 and 926, the transmitting antennas of access point 900 utilize beamforming in order to improve the signal-to-noise ratio of forward links for the different access terminals 916 and 924. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

Referring to FIG. 10, a block diagram of an aspect of a transmitter system 1010 (also known as the access point) and a receiver system 1050 (also known as access terminal) in a MIMO system 1000 is illustrated. At the transmitter system 1010, traffic data for a number of data streams is provided from a data source 1012 to a transmit (TX) data processor 1014.

In an aspect, each data stream is transmitted over a respective transmit antenna. TX data processor 1014 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 1030.

The modulation symbols for all data streams are then provided to a TX MIMO processor 1020, which may further process the modulation symbols (e.g., for OFDM). TX MIMO processor 1020 then provides N_{T} modulation symbol streams to N_{T} transmitters (TMTR) 1022a through 1022t. In certain aspects, TX MIMO processor 1020 applies beamforming weights to the symbols of the data streams and to the antenna from which the symbol is being transmitted.

Each transmitter 1022 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 1022a through 1022t are then transmitted from N_{T} antennas 1024a through 1024t, respectively.

At receiver system 1050, the transmitted modulated signals are received by N_{R} antennas 1052a through 1052r and the received signal from each antenna 1052 is provided to a respective receiver (RCVR) 1054a through 1054r. Each receiver 1054 conditions (e.g., filters, amplifies, and downconverts) a respective received signal, digitizes the conditioned signal to provide samples, and further processes the samples to provide a corresponding “received” symbol stream.

An RX data processor 1060 then receives and processes the N_{R} received symbol streams from N_{R} receivers 1054 based on a particular receiver processing technique to provide N_{T} “detected” symbol streams. The RX data processor 1060 then demodulates, deinterleaves, and decodes each detected symbol stream to recover the traffic data for the data stream. The processing by RX data processor 1060 is complementary to that performed by TX MIMO processor 1020 and TX data processor 1014 at transmitter system 1010.

A processor 1070 periodically determines which pre-coding matrix to use (discussed below). Processor 1070 formulates a reverse link message comprising a matrix index portion and a rank value portion.

The reverse link message may comprise various types of information regarding the communication link and/or the received data stream. The reverse link message is then processed by a TX data processor 1038, which also receives traffic data for a number of data streams from a data source 1036, modulated by a modulator 1080, conditioned by transmitters 1054a through 1054r, and transmitted back to transmitter system 1010.

At transmitter system 1010, the modulated signals from receiver system 1050 are received by antennas 1024, conditioned by receivers 1022, demodulated by a demodulator 1040, and processed by a RX data processor 1042 to extract the reserve link message transmitted by the receiver system 1050. Processor 1030 then determines which pre-coding matrix to use for determining the beamforming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In an aspect, Logical Traffic Channels comprises a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

In an aspect, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), a Uplink Shared Data Channel (UL-SDCH) and plurality of PHY channels. The PHY channels comprise a set of DL channels and UL channels. The DL PHY channels may comprise:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

For the purposes of the present document, the following abbreviations may apply:

AM Acknowledged Mode

AMD Acknowledged Mode Data

ARQ Automatic Repeat Request

BCCH Broadcast Control CHannel

BCH Broadcast CHannel

C- Control-

CCCH Common Control CHannel

CCH Control CHannel

CCTrCH Coded Composite Transport Channel

CP Cyclic Prefix

CRC Cyclic Redundancy Check

CTCH Common Traffic CHannel

DCCH Dedicated Control CHannel

DCH Dedicated CHannel

DL DownLink

DSCH Downlink Shared CHannel

DTCH Dedicated Traffic CHannel

FACH Forward link Access CHannel

FDD Frequency Division Duplex

L1 Layer 1 (physical layer)

L2 Layer 2 (data link layer)

L3 Layer 3 (network layer)

LI Length Indicator

LSB Least Significant Bit

MAC Medium Access Control

MBMS Multimedia Broadcast Multicast Service

MCCH MBMS point-to-multipoint Control CHannel

MRW Move Receiving Window

MSB Most Significant Bit

MSCH MBMS point-to-multipoint Scheduling CHannel

MTCH MBMS point-to-multipoint Traffic CHannel

PCCH Paging Control CHannel

PCH Paging CHannel

PDU Protocol Data Unit

PHY PHYsical layer

PhyCH Physical CHannels

RACH Random Access CHannel

RDS Radio Data System

RLC Radio Link Control

RRC Radio Resource Control

SAP Service Access Point

SDU Service Data Unit

SHCCH SHared channel Control CHannel

SN Sequence Number

SUFI SUper FIeld

TCH Traffic CHannel

TDD Time Division Duplex

TFI Transport Format Indicator

TM Transparent Mode

TMD Transparent Mode Data

TTI Transmission Time Interval

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

MBSFN multicast broadcast single frequency network

MCE MBMS coordinating entity

MCH multicast channel

DL-SCH downlink shared channel

MSCH MBMS control channel

PDCCH physical downlink control channel

PDSCH physical downlink shared channel

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 602.11 (Wi-Fi), IEEE 602.16 (WiMAX), IEEE 602.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 602.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. A method for facilitating communication between two or more applications, the method comprising:
receiving, by an extension module, a request from a first application to communicate with one or more applications;
establishing a communication link between the first and at least one of the one or more applications, wherein the communication link allows the first and the at least one of the one or more applications to communicate at least one of data or control information; and
storing, by the extension module, at least a portion of data communicated between the communicating applications.

2. The method of claim 1, further comprising:
transmitting at least a portion of the stored communications to at least one of: the first application, or the one or more applications, or one or more servers.

3. The method of claim 2, further comprising:
receiving a request, by a second application, to use at least a portion of the stored data to establish a second communication link with at least one of the one or more applications; and
establishing the second communication link, wherein the second application uses the at least a portion of the stored data to control at least one of the state or status of at least one of the one or more applications.

4. The method of claim 2, wherein at least one of the one or more servers is associated with at least one of the communicating applications.

5. The method of claim 2, wherein the transmitting to the one or more servers further comprising transmitting using at least one of: a JSON or a XML request and response protocol.

6. The method of claim 2, wherein the transmitting to the one or more servers further comprising distributing execution of at least one a portion of the one or more applications to the one or more servers.

7. The method of claim 6, wherein the at least one a portion of the one or more applications distributed to the one or more servers for execution includes a processor intensive portion of the one or more applications.

8. The method of claim 2, further comprising:
receiving, from at least one of the one or more servers, at least one content item for at least one of the communicating applications in response to the transmitted communications.

9. The method of claim 8, further comprising
storing, by the extension module, the received at least one content item for access by at least one of the one or more applications.

10. The method of claim 8, wherein the received at least one content item includes at least a portion of an audio file received from the one or more servers in response to the transmitted communications, and wherein the at least a portion of the audio file is stored by the extension module for access by at least one of the one or more applications.

11. The method of claim 1, wherein the receiving further comprises:
receiving one or more objects from the first application to communicate to at least two applications, wherein the one or more objects include at least one of: a command, data, control information, or a message;
queuing the received objects; and
serving the queued objects based on a predefined priority among the at least two applications.

12. The method of claim 11, wherein the servicing further comprises serving using at least one of a round robin process, or a time-sliced process, or any combination thereof.

13. The method of claim 1, wherein the receiving further comprises:
receiving a request from the first application in a format that is not compatible with one or more formats used by the one or more applications; and
translating the received request into one or more formats compatible with the one or more formats used by the one or more applications.

14. The method of claim 1, wherein the control information includes at least one of status control or state control information for at least one of the communicating applications.

15. The method of claim 14, wherein the status control information includes control information to allow a requesting application to perform at least one of: initiating a requested application, or changing the requested application to background running status, or changing the requested application to foreground running status, or changing the requested application to idle mode status, or terminating the requested application.

16. The method of claim 14, wherein the state control information includes allowing a requesting application to perform at least one of: modifying a volume associated with a requested application, or modifying a display characteristic associated with the requested application, or modifying an input option associated with the requested application, or modifying an output option associated with the requested application.

17. The method of claim 1, wherein the data communicated between first and at least one of the one or more applications is obtained from at least one of: the first application, at least one of the one or more applications, or a third application which aggregated data from one or more sources.

18. The method of claim 17, wherein the aggregated data was aggregated in response to a request by at least one of the one or more applications.

19. The method of claim 1, further comprising:
using the at least a portion of the stored data to profile a user based on usage of at least one of the one or more applications.

20. The method of claim 2, wherein the first application is an FM-RDS application, the second application is a music download service application, the communicated data includes at least a portion of RDS data or digital music data, the control information includes at least one of: control of a music download service application purchasing function, and communications stored includes at least a portion of: the RDS data, or the digital music data, or a purchasing record, or any combination thereof.

21. At least one processor configured to facilitate communication between two or more applications:
a first module for receiving, by an extension module, a request from a first application to communicate with one or more applications;
a second module for establishing a communication link between the first and at least one of the one or more applications, wherein the communication link allows the first and the at least one of the one or more applications to communicate at least one of data or control information; and
a third module for storing, by the extension module, at least a portion of data communicated between the communicating applications.

22. A computer program product, comprising:
a computer-readable medium comprising:
a first set of codes for causing a computer to receive, by an extension module, a request from a first application to communicate with one or more applications;
a second set of codes for causing the computer to establish a communication link between the first and at least one of the one or more applications, wherein the communication link allows the first and the at least one of the one or more applications to communicate at least one of data or control information; and
a third set of codes for causing the computer to store, by the extension module, at least a portion of data communicated between the communicating applications.

23. An apparatus, comprising:
means for receiving, by an extension module, a request from a first application to communicate with one or more applications;
means for establishing a communication link between the first and at least one of the one or more applications, wherein the communication link allows the first and the at least one of the one or more applications to communicate at least one of data or control information; and
means for storing, by the extension module, at least a portion of data communicated between the communicating applications.

24. An apparatus, comprising:
an extension module for:
receiving a request from a first application to communicate with a one or more applications; and
establishing a communication link between the first and at least one of the one or more applications, wherein the communication link allows the first and the at least one of the one or more applications to communicate at least one of data or control information; and
a storage module for:
storing at least a portion of data communicated between the communicating applications.

25. The apparatus of claim 24, wherein the extension module is further operable for:
transmitting at least a portion of the stored communications to at least one of: the first application, or the one or more applications, or one or more servers.

26. The apparatus of claim 25, wherein the extension module is further operable for:
receiving a request, by a second application, to use at least a portion of the stored data to establish a second communication link with at least one of the one or more applications; and
establishing the second communication link, wherein the second application uses the at least a portion of the stored data to control at least one of the state or status of at least one of the one or more applications.

27. The apparatus of claim 25, wherein at least one of the one or more servers is associated with at least one of the communicating applications.

28. The apparatus of claim 25, wherein the transmitting to the one or more servers further comprising transmitting using at least one of: a JSON or a XML request and response protocol.

29. The apparatus of claim 25, wherein the transmitting to the one or more servers further comprising distributing execution of at least one a portion of the one or more applications to the one or more servers.

30. The apparatus of claim 29, wherein the at least one a portion of the one or more applications distributed to the one or more servers for execution includes a processor intensive portion of the one or more applications.

31. The apparatus of claim 25, wherein the extension module is further operable for:
receiving, from at least one of the one or more servers, at least one content item for at least one of the communicating applications in response to the transmitted communications.

32. The apparatus of claim 31, wherein the storage module is further operable for:
storing the received at least one content item for access by at least one of the one or more applications.

33. The apparatus of claim 31, wherein the received at least one content item includes at least a portion of an audio file received from the one or more servers in response to the transmitted communications, and wherein the at least a portion of the audio file is stored by the extension module for access by at least one of the one or more applications.

34. The apparatus of claim 24, wherein the extension module is further operable for:
receiving one or more objects from the first application to communicate to at least two applications, wherein the one or more objects include at least one of: a command, data, control information, or a message;
queuing the received objects; and
serving the queued objects based on a predefined priority among the at least two applications.

35. The apparatus of claim 34, wherein the servicing further comprises serving using at least one of a round robin process, or a time-sliced process, or any combination thereof.

36. The apparatus of claim 24, wherein the extension module is further operable for:
receiving a request from the first application in a format that is not compatible with one or more formats used by the one or more applications; and
translating the received request into one or more formats compatible with the one or more formats used by the one or more applications.

37. The apparatus of claim 24, wherein the control information includes at least one of status control or state control information for at least one of the communicating applications.

38. The apparatus of claim 37, wherein the status control information includes allowing the requesting application to perform at least one of: initiating a requested application, or changing the requested application to background running status, or changing the requested application to foreground running status, or changing the requested application to idle mode status, or terminating the requested application.

39. The apparatus of claim 37, wherein the state control information includes allowing the requesting application to perform at least one of: modifying a volume associated with a requested application, or modifying a display characteristic associated with the requested application, or modifying an input option associated with the requested application, or modifying an output option associated with the requested application.

40. The apparatus of claim 24, wherein the data communicated between first and at least one of the one or more applications is obtained from at least one of: the first application, at least one of the one or more applications, or a third application which aggregated data from one or more sources.

41. The apparatus of claim 41, wherein the aggregated data was aggregated in response to a request by at least one of the one or more applications.

42. The apparatus of claim 24, wherein the extension module is further operable for:
using the at least a portion of the stored data to profile a user based on usage of at least one of the one or more applications.

43. The apparatus of claim 25, wherein the first application is an FM-RDS application, the second application is a music download service application, the communicated data includes at least a portion of RDS data or digital music data, the control information includes at least one of: control of a music download service application purchasing function, and communications stored includes at least a portion of: the RDS data, or the digital music data, or a purchasing record, or any combination thereof.

44. A method for providing content to one or more of a plurality of devices, the method comprising:
receiving, by an extension server, from a plurality of devices, at least a portion of communications between one or more applications stored by an extension module on each of the plurality of devices, wherein the stored communications include at least one of data or control information for at least one of the communicating applications;
obtaining at least one content item in response to the received communications;
storing at least a portion of information received from the plurality of devices;
analyzing the stored information from the plurality of devices; and
presenting data derived from the analyzed stored information.

45. The method of claim 44, further comprising:
transmitting each requested content item to each of the requesting devices for reception by at least one of the one or more applications associated with the requesting device.

46. The method of claim 44, wherein:
the storing the portion of information further includes a plurality of content item requests;
the analyzing of the stored information further includes at least one of summing or categorizing the plurality of content item requests; and
the presenting further includes presenting at least one of the summing results or categorizing results to at least one of the plurality of devices.

47. The method of claim 46, wherein at least one of the plurality content item requests further comprises a file requests for: an audio file, or an executable file, or a video file, or a multi-media file.

48. The method of claim 44, wherein the receiving further comprises receiving using at least one of: a JSON or a XML request and response protocol.

49. The method of claim 44, wherein the receiving further comprises receiving instructions to execution at least one a portion of the one or more applications.

50. The method of claim 49, wherein the received portion includes a processor intensive portion of the one or more applications.

51. The method of claim 44, wherein the obtaining further comprises obtaining the at least one content item from at least one of one or more servers, wherein the at least one of the one or more servers is associated with at least one of the one or more applications.

52. The method of claim 44, wherein the presenting further comprises graphically displaying the data derived from the analyzed stored information.

53. The method of claim 44, wherein the presenting further comprises plotting the data derived from the analyzed stored information on a map.

54. The method of claim 44, wherein the presenting further comprises organizing the data derived from the analyzed stored information into one or more categories, wherein the one or more categories includes at least one of: a map category, or a popularity of an application category, or a trends category, or a reviews category, or a feedback category, or an application specific category.

55. The method of claim 54, wherein at least one of the one or more categories includes one or more subcategories, wherein the one or more subcategories includes at least one of: a frequency of usage subcategory, or an application session duration subcategory, or a number of unique users subcategory, or a number of times an application has been used subcategory, or a user activity during application usage subcategory, or a application usage location subcategory, or a application usage time of day subcategory, or a application usage per a service plan subcategory, or a application usage over a predefined duration of time subcategory.

56. The method of claim 55, wherein the user activity during application usage subcategory includes the data derived from the analyzed stored information which indicts the device is geographically, stationary, or moving along a known street, or moving along a known mass transit route.

57. At least one processor configured to provide functionalities to one or more of a plurality of devices:
a first module for receiving, by an extension server, from a plurality of devices, at least a portion of communications between one or more applications stored by an extension module on each of the plurality of devices, wherein the stored communications include at least one of data or control information for at least one of the communicating applications;
a second module for obtaining at least one content item in response to the received communications;
a third module for storing at least a portion of information received from the plurality of devices;
a fourth module for analyzing the stored information from the plurality of devices; and
a fifth module for presenting data derived from the analyzed stored information.

58. A computer program product, comprising:
a computer-readable medium comprising:
a first set of codes for causing a computer to receive, by an extension server, from a plurality of devices, at least a portion of communications between one or more applications stored by an extension module on each of the plurality of devices, wherein the stored communications include at least one of data or control information for at least one of the communicating applications;
a second set of codes for causing the computer to obtain at least one content item in response to the received communications; and
a third set of codes for causing the computer to store at least a portion of information received from the plurality of devices;
a fourth set of codes for causing the computer to analyze the stored information from the plurality of devices; and
a fifth set of codes for causing the computer to present data derived from the analyzed stored information

59. An apparatus, comprising:
means for receiving, by an extension server, from a plurality of devices, at least a portion of communications between one or more applications stored by an extension module on each of the plurality of devices, wherein the stored communications include at least one of data or control information for at least one of the communicating applications;
means for obtaining at least one content item in response to the received communications;
means for storing at least a portion of information received from the plurality of devices;
means for analyzing the stored information from the plurality of devices; and
means for presenting data derived from the analyzed stored information.

60. An apparatus, comprising:
a receiver operable for:
receiving from a plurality of devices, at least a portion of communications between one or more applications stored by an extension module on each of the plurality of devices, wherein the stored communications include at least one of data or control information for at least one of the communicating applications; and
an application server module operable for:
obtaining at least one content item in response to the received communications;
storing at least a portion of information received from the plurality of devices;
analyzing the stored information from the plurality of devices; and
presenting data derived from the analyzed stored information.

61. The apparatus of claim 60, further comprising a transmitter operable for:
transmitting each requested content item to each of the requesting devices for reception by at least one of the one or more applications associated with the requesting device.

62. The apparatus of claim 61, wherein the application server module is further operable for:
storing a plurality of content item requests;
performing at least one of summing or categorizing the plurality of content item requests; and
presenting at least one of the summing results or categorizing results to at least one of the plurality of devices.

63. The apparatus of claim 62, wherein at least one of the plurality content item requests further comprises a file requests for: an audio file, or an executable file, or a video file, or a multi-media file.

64. The apparatus of claim 61, wherein the receiver is further operable for receiving using at least one of: a JSON or a XML request and response protocol.

65. The apparatus of claim 61, wherein the receiver is further operable for receiving instructions to execution at least one a portion of the one or more applications.

66. The apparatus of claim 65, wherein the received portion includes a processor intensive portion of the one or more applications.

67. The apparatus of claim 61, wherein the application server module is further operable for obtaining the at least one content item from at least one of one or more servers, wherein the at least one of the one or more servers is associated with at least one of the one or more applications.

68. The apparatus of claim 61, wherein the application server module is further operable for graphically displaying the data derived from the analyzed stored information.

69. The apparatus of claim 61, wherein the application server module is further operable for plotting the data derived from the analyzed stored information on a map.

70. The apparatus of claim 61, wherein the application server module is further operable for organizing the data derived from the analyzed stored information into one or more categories, wherein the one or more categories includes at least one of: a map category, or a popularity of an application category, or a trends category, or a reviews category, or a feedback category, or an application specific category.

71. The apparatus of claim 70, wherein at least one of the one or more categories includes one or more subcategories, wherein the one or more subcategories includes at least one of: a frequency of usage subcategory, or an application session duration subcategory, or a number of unique users subcategory, or a number of times an application has been used subcategory, or a user activity during application usage subcategory, or a application usage location subcategory, or a application usage time of day subcategory, or a application usage per a service plan subcategory, or a application usage over a predefined duration of time subcategory.

72. The apparatus of claim 71, wherein the user activity during application usage subcategory includes the data derived from the analyzed stored information which indicts the device is geographically, stationary, or moving along a known street, or moving along a known mass transit route.
